(19) United States
(12) Patent Application Publication
(10) Pub. No.: US 2013/0216928 A1
(43) Pub. Date: Aug. 22, 2013

(54) ELECTRONIC DEVICE

(71) Applicants: Masayoshi Nakajima, Yokohama-shi (JP); Akira Koyama, Yokohama-shi (JP); Yoshiyuki Shinoda, Yokohama-shi (JP)

(72) Inventors: Masayoshi Nakajima, Yokohama-shi (JP); Akira Koyama, Yokohama-shi (JP); Takanobu Hayakawa, Yokohama-shi (JP); Yoshiyuki Shinoda, Yokohama-shi (JP)

(73) Assignee: KYOCERA CORPORATION, Kyoto (JP)

(21) Appl. No.: 13/581,025

(22) PCT Filed: Feb. 24, 2011
(86) PCT No.: PCT/JP2011/054142

§ 371 Date: Apr. 5, 2013

(30) Foreign Application Priority Data
Feb. 24, 2010 (JP) 2010-038509

(51) Int. Cl. H01M 8/04

(52) U.S. Cl. CPC H01M 8/04186
USPC 429/447

(57) ABSTRACT

According to an aspect, an electronic device include: a fuel supply port; a fuel tank for storing a liquid fuel to be supplied from the first supply port through a first fluid channel; a fuel cell for generating power by using the liquid fuel supplied from the fuel tank through a second fluid channel; a first valve that is installed in the second fluid channel for controlling supply of the liquid fuel to the fuel cell; a voltage generator that is installed in the first fluid channel for generating a voltage using a pressure of the liquid fuel that is supplied from the fuel supply port; and a valve control unit for controlling an open/closed state of the first valve according to an application of the voltage.

### CROSS-REFERENCE TO RELATED APPLICATION

This application is a National Stage of PCT international application Ser. No. PCT/JP2011/054142 filed on Feb. 24, 2011 which designates the United States, and which is based upon and claims the benefit of priority from Japanese Patent Application No. 2010-038509, filed on Feb. 24, 2010.

### FIELD

The present disclosure relates to an electronic device in which a fuel cell is mounted.

### BACKGROUND

Mobile phones in which a fuel cell is mounted are known as this kind of electronic devices. For example, Patent Literature 1 discloses a mobile phone configured such that a fuel cell and a fuel tank are accommodated in a housing, and power is generated from the fuel cell when fuel such as methanol is injected from a fuel supply port provided outside the housing to the fuel cell. Moreover, Patent Literature 2 discloses a mobile phone of a hybrid type configured such that a fuel cell and a secondary cell (lithium-ion battery, etc.) are accommodated in a housing and charging from the fuel cell to the secondary cell is performed.

### CITATION LIST

### Patent Literature

Patent Literature 1: Japanese Patent Application Laid-Open No. 2007-88804

Patent literature 2: Japanese Patent Application Laid-Open No. 2004-247995

### Technical Problem

Incidentally, an electronic device such as a fuel-cell-mounted mobile phone is provided with a valve that allows/stops supply of fuel between a fuel tank and a fuel cell, or with a valve that controls a flow rate of fuel. Such a valve is maintained in a normally closed state from the viewpoint of safety and becomes open only during a period of power generation/charging by causing a voltage to be applied from a power supply of a secondary cell installed in the housing of the electronic device. However, when an output voltage of a power supply drops to or below a predetermined value and as a result power cannot be applied from the power supply to the valve, the valve cannot be opened. As a result, it is concerned that the fuel is not supplied to the fuel cell and consequently the fuel cell cannot be started.

For the foregoing reasons, there is a need for an electronic device capable of opening a valve even when a voltage cannot be applied from a power supply to the valve due to a low output voltage of the power supply.

### SUMMARY

According to an aspect, an electronic device include: a fuel supply port; a fuel tank for storing a liquid fuel to be supplied from the first supply port through a first fluid channel; a fuel cell for generating power by using the liquid fuel supplied from the fuel tank through a second fluid channel; a first valve that is installed in the second fluid channel for controlling supply of the liquid fuel to the fuel cell; a voltage generator that is installed in the first fluid channel for generating a voltage using a pressure of the liquid fuel that is supplied from the fuel supply port; and a valve control unit for controlling an open/closed state of the first valve according to an application of the voltage.

According to another aspect, the valve control unit switches the first valve to the open state based on the voltage generated by the voltage generator.

According to another aspect, the electronic device further includes an auxiliary power supply that is switched to an electrically connected state or an electrically disconnected state with respect to the first valve by the valve control unit. The valve control unit switches the auxiliary power supply and the first valve from the electrically disconnected state to the electrically connected state to apply a voltage of the auxiliary power supply to the first valve so that the first valve is switched from the closed state to the open state.

According to another aspect, the valve control unit includes a latch circuit for maintaining the electrically connected state between the auxiliary power supply and the first valve.

According to another aspect, the electronic device further includes: a bypass fluid channel that connects the first fluid channel and the second fluid channel; and a second valve that is installed in a connection between the first fluid channel and the bypass fluid channel for selectively supplying the liquid fluid supplied from the fluid supply port either to the first fluid channel or to the bypass fluid channel. The voltage generator is installed in the first fluid channel and between the fuel supply port and the second valve. The valve control unit applies the voltage generated by the voltage generator to the second valve so that the second valve is switched to a state in which the bypass fluid channel and the first fluid channel communicate with each other, supplies the liquid fluid to the fluid cell through the bypass fluid channel so that power is generated by the fuel cell, and applies the voltage generated by the power generation to the first valve so that the first valve is switched from the closed state to the open state

According to another aspect, the voltage generator is a piezoelectric element.

According to another aspect, the electronic device further includes a secondary cell. The secondary cell is charged with a voltage generated by the fuel cell.

### Advantageous Effects of Invention

According to the electronic device of the present invention, even when the voltage of the power supply is low and hence the voltage cannot be supplied from the power supply to the valve, the valve can be opened and the fuel cell can start operating.

### BRIEF DESCRIPTION OF DRAWINGS

FIG. 1 is a perspective view illustrating the appearance of an electronic device (mobile phone) according to a first embodiment.

FIG. 2 is a schematic diagram of a piezoelectric element disposed in a first fluid channel.

FIG. 3 is a block diagram of a fuel cell unit and a valve control circuit according to the first embodiment.

FIG. 4 is a flowchart illustrating a procedure for starting a fuel cell by using the valve control circuit according to the first embodiment.

FIG. 5 is a block diagram of a fuel cell unit and a valve control circuit according to a second embodiment.

FIG. 6 is a flowchart illustrating a procedure for starting a fuel cell by using the valve control circuit according to the second embodiment.

### DESCRIPTION OF EMBODIMENTS

Hereafter, the present invention will be described with reference to the accompanying drawings. However, the present invention is not limited by the following embodiments of the invention. Moreover, constitutional components described in the following embodiments include components that can be easily considered by those skilled in the art, components that are substantially the same as those components, and so-called equivalents of those components. In the following description, a mobile phone is described as an example of an electronic device. However, an object to which the present invention can be applied is not limited thereto. For example, the present invention can be applied to PHSs (Personal Handy phone Systems), PDAs (Personal Data Assistants), portable navigation devices, notebook-sized personal computers, portable gaming devices, and the like.

### First Embodiment

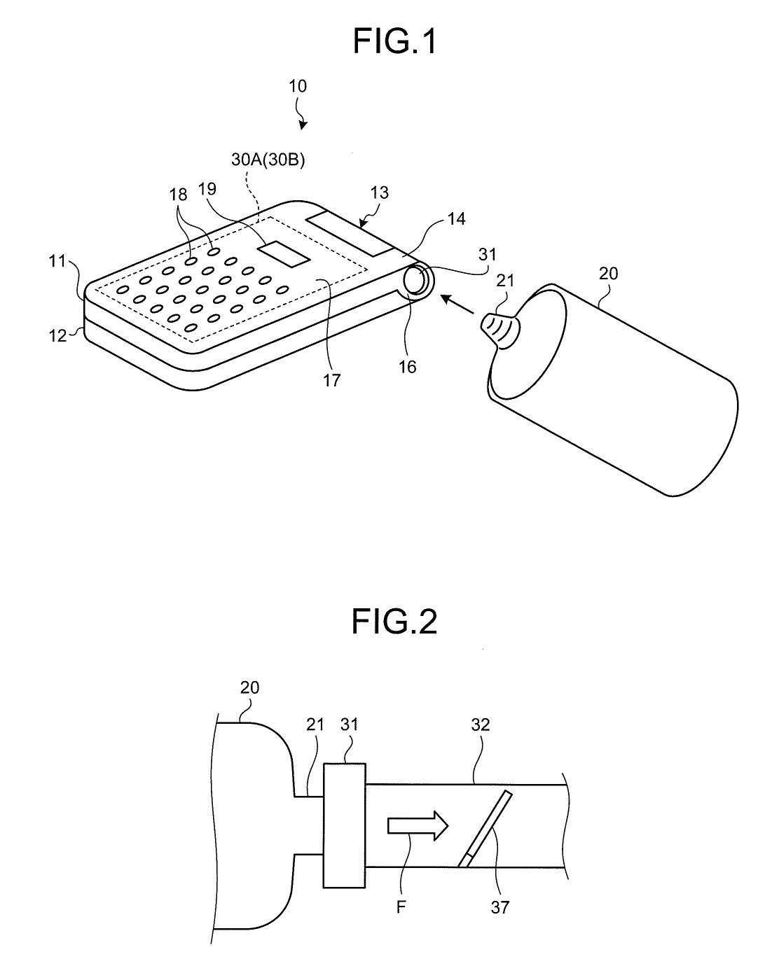

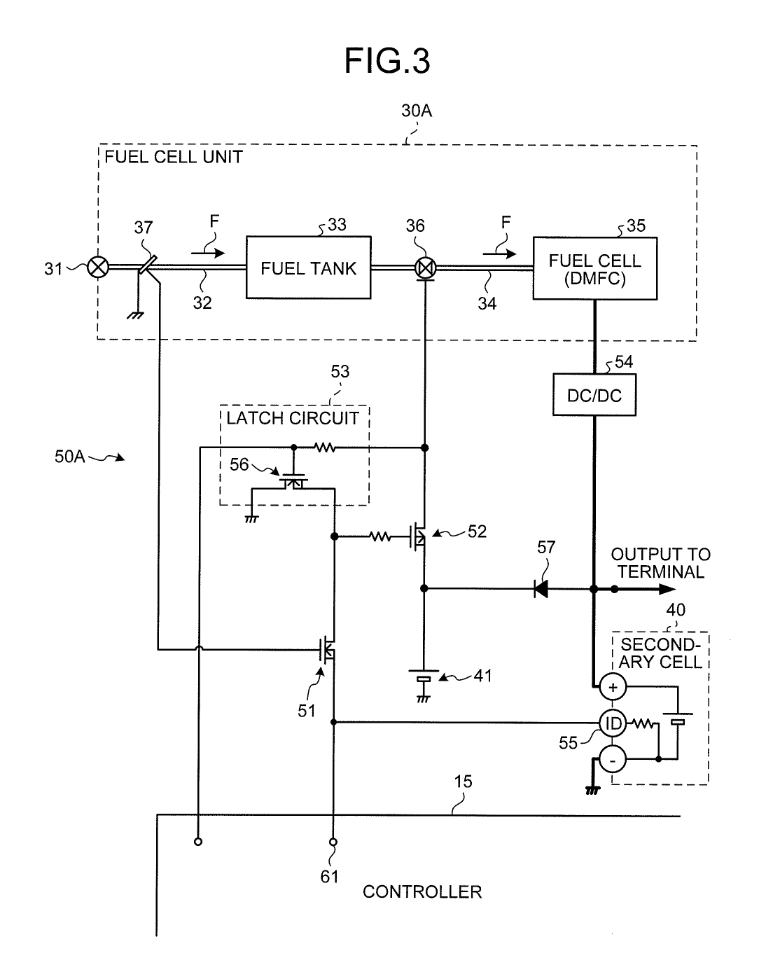

FIG. 1 is a perspective view illustrating the appearance of a mobile phone (electronic device) 10 according to the embodiment. FIG. 2 is a schematic diagram of a piezoelectric element 37 disposed in a first fluid channel 32 inside the mobile phone 10 illustrated in FIG. 1, and FIG. 3 is a block diagram of a fuel cell unit 30 and a valve control circuit (valve control unit) 50A accommodated in the mobile phone 10.

[Overall Structure of Mobile Phone]

The mobile phone 10 illustrated in FIG. 1 is a mobile phone of a so-called foldable type, and the folded state is illustrated in FIG. 1. This mobile phone 10 includes a first housing 11 and a second housing 12. In the first housing 11, a receiver, and a main display (neither shown in the figure) which includes a liquid crystal display or the like are provided on the surface which faces a second housing 12. A base portion 14 of the first housing 11 is supported by a hinge portion 13 so that it can be opened and closed with respect to the second housing 12. The second housing 12 accommodates a controller 15 (See FIG. 3) that controls respective parts of the mobile phone 10. In addition, on the surface of the second housing 12 which faces the first housing 11, a microphone and an operation unit (neither shown in the figure) which includes a plurality of operation keys are provided.

When the first housing 11 is opened with respect to the second housing 12, the mobile phone enters a state (communicable state) in which the main display of the first housing 11 is exposed and the operation unit of the second housing 12 is opened. On the other hand, from this state, when the first housing is rotated about the hinge portion 13, the operation unit and the main display are simultaneously covered with the second housing 12 as illustrated in FIG. 1.

The fuel cell unit 30A is accommodated in the first housing 11. As illustrated in FIG. 1, an end face 16 of the hinge portion 13 in the first housing 11 is provided with a fuel supply port 31 through which a liquid fuel (hereafter, referred to as “fuel”) to be used by the fuel cell unit 30A is introduced from the outside. When the fuel in a fuel cartridge 20 is emitted from a supply nozzle 21 in a state in which the supply nozzle 21 of the fuel cartridge 20 is inserted in the fuel supply port 31, the fuel is supplied to the fuel cell unit 30A in the first housing 11, and consequently power is generated by the fuel cell 35 (See FIG. 3).

A plurality of heat exhaust ports 18 to emit heat generated from the fuel cell unit 30A is formed in a surface 17 of the mobile phone 10 which serves as an upper surface when the mobile phone 10 is folded. Moreover, the surface 17 is provided with a sub-display 19 including a liquid crystal display or the like. The sub-display 19 displays the remaining battery level of a secondary cell 40 (See FIG. 3) accommodated in the second housing 12, etc. When the remaining battery level drops to a predetermined value or below, the display displays in a manner of urging the user to replenish the fuel.

The second housing 12 accommodates an auxiliary power supply 41 and the secondary cell 40 to which the power generated by the fuel cell 35 in the fuel cell unit 30A is charged, and a valve control circuit 50A to be described later.

Next, referring to FIG. 3, the fuel cell unit 30A, the secondary cell 40, the auxiliary power supply 41, and the valve control circuit 50A accommodated in the mobile phone 10 will be described in detail.

[Fuel Cell Unit]

The fuel cell unit 30A includes the fuel supply port 31, a first fluid channel 32, a fuel tank 33, a second fluid channel 34, the fuel cell 35, a first valve 36, and a piezoelectric element (voltage generator) 37 as illustrated in FIG. 3.

The fuel supply port 31 is a round opening provided in one end surface 16 of a hinge portion 13 in the first housing 11 as illustrated in FIG. 1, and is covered with a sealing cap (not illustrated) when fuel is not being supplied. The fuel supply port 31 is connected to the fuel tank 32 in the first housing 11 through the first fluid channel 32 as illustrated in FIG. 3.

The first fluid channel 32 is piping that connects the fuel supply port 31 to the fuel tank 33, and is configured by using a bellows-type expansion pipe. The piezoelectric element 37 to be described later is disposed in this first fluid channel 32.

The fuel tank 33 is a vessel having a space inside which the fuel is stored, and is made of, for example, a material of resin. The fuel F supplied from the fuel supply port 31 through the first fluid channel 32 is first stored in the fuel tank 33, and then supplied to the fuel cell 35 through the second fluid channel 34 and the first valve 36.

The second fluid channel 34 is piping that connects the fuel tank 33 to the fuel cell 35, and is configured by using a bellows-type expansion pipe like the first fluid channel 32. The first valve 36 is disposed in the middle of the second fluid channel 34.

The fuel cell 35 consumes the fuel F to generate power. In the embodiment, a direct-methanol-type fuel cell (DMFC: Direct Methanol fuel cell) that uses methanol (CH₃OH) as a fuel is used as the fuel cell 35. The fuel cell 35 includes a cell stack in which a plurality of fuel battery cells is connected to each other, each fuel battery cell including a fuel electrode, a solid polymer electrolytic membrane, and a gas diffusion electrode. The fuel cell 35 generates power by electrochemical reaction between the introduced air and the fuel F in the cell stack. In the embodiment, the fuel cell 35 is used only for the purpose of charging the secondary cell 40 and the auxiliary power supply 41. In other words, the power generated by the fuel cell 35 is assumed not to be supplied to various loads in the mobile phone 10. However, without being limited to this purpose, both of the power generated by the power generation in the fuel cell 35 and the power of the secondary cell 40 may be supplied to various loads of the mobile phone 10. Alternatively, only the power generated by the power generation in the fuel cell 35 may be supplied to the loads of the mobile phone 10, without other power supplies such as the secondary cell being used.

The first valve 36 is installed in the middle of the second fluid channel 34, and controls the supply of fuel F which is supplied from the fuel tank 33 to the fuel cell 35. The term “valve” is a generic term used to refer to a valve body and a valve opening and closing unit that controls the opening and closing of the valve body. As for the valve, a voltage is applied to the valve opening and closing unit, and as a result the valve body opens or closes. Hereinafter, “a voltage is applied to a valve opening and closing unit of a first valve 36” is expressed as “a voltage is applied to a first valve 36”, and “a valve opening and closing unit of a first valve is electrically connected with an auxiliary power supply 41” is expressed as “a first valve is electrically connected with an auxiliary power supply 41”.

The first valve 36 is configured as an opening and closing valve that switches the second fluid channel 34 between only two states, an open state and a closed state, or as a flow rate control valve that can adjust an opening degree of the second fluid channel 34. The first valve 36 uses an electromagnetic valve, a piezoelectric valve which controls the flow of a fluid using a piezoelectric element which is deformed when a voltage is applied thereto, etc. In the embodiment, the piezoelectric valve is used because it is lightweight and compact. Moreover, a piezoelectric valve used in the embodiment is a type that can be switched between two states, an open state and a closed state.

The first valve 36 is installed for the following two reasons. Firstly, in the power generation of the fuel cell 35, the amount of generated power needs to be controlled in accordance with the environment of power generation such as high temperature, low temperature, or lack of oxygen, and thus the flow rate of fuel supplied to the fuel cell 35 needs to be regulated in accordance with circumstances. Secondarily, since small and lightweight mobile phones 10 become in demand in recent years, there is a difficulty in mounting the fuel cell with the capacity which is sufficient to control the entire system of the mobile phone 10 when mounting the fuel cell 35 in the mobile phone 10. Accordingly, it becomes common practice to use the secondary cell 40 in combination with the fuel cell. Therefore, when the power cannot be supplied from the secondary cell 40 to various loads of the mobile phone 10 for the reason that the secondary cell 40 is removed from the mobile phone 10 or the reason that the output voltage of the secondary cell 40 is low in level, if the loads are powered only with the power generated by the fuel cell 35, there is a concern that the control of the system becomes unstable. Therefore, the first valve 36 is normally kept closed except for a period during which the power supply to the secondary cell 40 and the auxiliary power supply 41 is performed so that the stability of the system can be secured. In addition, when the secondary cell 40 is removed from the mobile phone 10, the first valve 36 is closed and the fuel supply to the fuel cell 35 is stopped even during the power generation/charging.

The first valve 36 is configured to open and close by being supplied with the power from the secondary cell 40 during a normal operation. Therefore, when the output voltage of secondary cell 40 is insufficient and the fuel F is not stored in the fuel tank 33, the power cannot be supplied to the first valve 36. Under this condition, there is a concern that the first valve 36 having been in a closed state may not be opened. Therefore, the first valve 36 is electrically connected with the auxiliary power supply 41 through the valve control circuit 50A to be described later so as to receive the power from the auxiliary power supply 41 and thus to be opened in such an emergency.

The piezoelectric element (voltage generator) 37 is an element that generates a voltage when a pressure is applied thereto, and is disposed in the first fluid channel 32, and near the fuel supply port 31 as illustrated in FIG. 2. If the fuel F is injected from the supply nozzle 21 into the first fluid channel 32 at a given pressure in a state in which the supply nozzle 21 of the fuel cartridge 20 is inserted in the fuel supply port 31, the piezoelectric element 37 is deformed due to the pressure of the fuel F and thus generates the voltage. The piezoelectric element 37 is connected to the valve control circuit 50A that controls the opening and closing of the first valve 36 as illustrated in FIG. 3. Accordingly, the voltage generated by piezoelectric element 37 is applied to the valve control circuit 50A and as a result the auxiliary power supply 41 and the first valve 36 are switched from the electrically disconnected state to the electrically connected state. Under this condition, the power is supplied from the auxiliary power supply 41 to the first valve 36, and as a result the first valve 36 can be switched from the closed state to the open state. Well-known elements such as piezoelectric ceramics or quartz resonators can be used as the piezoelectric element 37.

The piezoelectric element 37 is used as an example of the voltage generator in the embodiment. The voltage generator is not limited to the piezoelectric element 37, but other elements may be used. For example, a power generation mechanism that uses an impeller may be used as the voltage generator. Specifically, the impeller is installed in the first fluid channel 32, and is rotated by the fuel F supplied from the fuel supply port 31. This rotary motion is transferred to a power generator so that a voltage is generated.

[Secondary Cell and Auxiliary Power Supply]

The secondary cell 40 is a power storage unit, such as a lithium-ion battery that stores the power generated by the fuel cell 35. The secondary cell 40 serves as a main power supply of the mobile phone 10, and thus supplies power to various loads of the mobile phone 10. Moreover, the secondary cell 40 supplies a voltage to the first valve 36 in the fuel cell unit 30A as described above so that the first valve 36 can be opened and closed.

The auxiliary power supply 41 is a power storage unit which stores the power generated by the fuel cell 35. For example, a super-capacitor (electric double layer capacitor) or the like is used as the auxiliary power supply 41. The auxiliary power supply 41 is not configured to supply the power to various loads of the mobile phone 10 under a normal condition. The auxiliary power supply 41 supplies the power to the first valve 36 instead of the secondary cell 40 when the output power of the secondary cell 40 is insufficient as described below. That is, The auxiliary power supply 41 serves as an ancillary power supply to switch the first valve from the closed state to the open state when the output power of the secondary cell 40 is insufficient. Specifically, the auxiliary power supply 41 is switched to be electrically connected or disconnected to the first valve 36 of the fuel cell unit 30A by the valve control circuit 50A. The auxiliary power supply 41 is maintained in the electrically disconnected state under a normal condition. However, when the output power of the secondary cell 40 is insufficient, the auxiliary power supply 41 is switched to the electrically connected state and consequently supplies the power to the first valve 36 instead of the secondary cell 40.

[Valve Control Circuit]

The valve control circuit 50A is an example of a circuitry that controls the opening and closing of the first valve 36 based on the pressure generated at the piezoelectric element 37. Specifically, the valve control circuit 50A is configured to cause the first valve 36, which has not been electrically connected with the auxiliary power supply 41, to be electrically connected with the auxiliary power supply 41 when the voltage generated by the piezoelectric element 37 is applied thereto, so that the first valve 36 can be opened.

The valve control circuit 50A includes a first field effect transistor 51 (hereinafter, referred to as “FET 51”), a second field effect transistor 52 (hereafter, referred to as “FET 52”), and a latch circuit 53 including a third field effect transistor 56 (hereafter, referred to as “FET 56”). Moreover, the valve control circuit 50A has a DC/DC convertor (Direct Current (DC) voltage converter) 54 between the fuel cell 35 and the secondary cell 40, and is configured to boost the output voltage of the fuel cell 35 by using the DC/DC converter 54 and then supply the resultant power to the secondary cell 40 and the auxiliary power supply 41.

The secondary cell 40 includes an ID resistance 55 which is unique to the secondary cell 40. The controller 15 detects the ID resistance 55 through a secondary cell detection terminal 61. The purpose of this is to prevent the first valve 36 from entering the open state under a situation in which the secondary cell 40 is removed from the mobile phone 10. The controller 15 determines that the secondary cell 40 is not in connection when the ID resistance 55 is not detected, and thus performs the control such that the first valve 36 does not open.

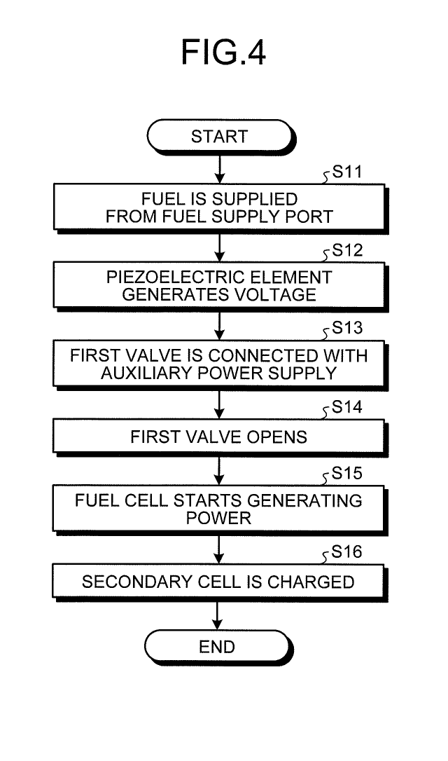

FIG. 4 is a flowchart illustrating the procedure to open the first valve 36 so that the fuel cell 35 starts by using the valve control circuit 50A when the output power of the secondary cell 40 is insufficient. Hereinafter, the above-mentioned procedure is described with reference to the FIGS. 3 and 4. The auxiliary power supply 41 is assumed to have a voltage enough to open the first valve 36.

The first valve 36 is maintained in the closed state under a normal condition. Under such a condition, it is assumed that the output voltage of the secondary cell 40 drops to or below a predetermined value and as a result the first valve 36 cannot be opened. In this state, when the supply nozzle 21 of the fuel cartridge 20 is inserted into the fuel supply port 31 by the user and the fuel F is injected from the fuel supply port 31 at a certain pressure (Step S11), the piezoelectric element 37 installed in the first fluid channel 32 is deformed due to the pressure of the liquid fuel F so that a voltage is generated (Step S12). Then, when the voltage generated by the piezoelectric element 37 is applied to a gate of the FET 51, the FET 51 is turned on (conducted). Since the FET 51 is turned on, the gate of the FET 52 becomes Low in level, so that the FET 52 is turned on. When the FET 52 is turned on, the first valve 36 is electrically connected with the auxiliary power supply 41 (Step S13), and the voltage of the auxiliary power supply 41 is applied to the first valve 36. As a result, the first valve 36 is switched to the open state (Step S14).

The latch circuit 53 is provided to maintain the open state of the first valve 36 even after the voltage supplied from the piezoelectric element 37 drops to 0. That is, in a case where the voltage of piezoelectric element 37 is generated for only a brief moment, when the voltage drops to 0, the FET 51 is turned off and the gate of FET 52 is not Low in level any more. As a result, since the FET 52 is turned off, an event in which the first valve 36 closes occurs. In order to avoid this event, the latch circuit 53 including the FET 56 is provided as illustrated in FIG. 3.

When the FET 52 is turned on in Step S13, since a voltage is applied from the auxiliary power supply 41 to the gate of the FET 56 of the latch circuit 53, the FET 56 is turned on and as a result the gate of the FET 52 drops to Low in level and the FET 52 is kept being ON. As a result, since the electrically connected state between the auxiliary power supply 41 and the first valve 36 is maintained, the first valve 36 will be maintained in the open state.

When the first valve 36 is maintained in the open state, the fuel F supplied from the fuel supply port 31 is supplied to the fuel cell 35, and the power generation by the fuel cell 35 is started (Step S15). The voltage output from the fuel cell 35 is boosted by the DC/DC convertor 54, and is then charged not only to the secondary cell 40 but also to the auxiliary power supply 41 through a diode 57 (Step S16).

As described above, the mobile phone 10 (electronic device) of the embodiment includes the piezoelectric element (voltage generator) 37 that generates the voltage using the pressure of the fuel F supplied from the fuel supply port 31, the valve control circuit 50 that switches the first valve 36 from the closed state to the open state based on the voltage generated by the piezoelectric element 37, and the auxiliary power supply 41 switched to be electrically connected or disconnected to the first valve 36 by the valve control circuit 50A.

Moreover, the valve control circuit 50A is configured in such a manner that, when the voltage generated by the piezoelectric element 37 is applied thereto, the auxiliary power supply 41 and the first valve 36 are switched from the electrically disconnected state to the electrically connected state, the voltage of the auxiliary power supply 41 is applied to the first valve 36, and the first valve 36 is switched from the closed state to the open state. According to the mobile phone 10 configured as described above, even when the output voltage of the secondary cell 40 is low, the first valve 36 can be surely opened and as a result the fuel cell 35 can be started.

Moreover, according to the mobile phone 10 of the embodiment, the first valve 36 can be opened only by addition of the valve control circuit 50A and the auxiliary power supply 41 to the fuel cell unit 10, without addition of a new member.

Moreover, according to the mobile phone 10 of the embodiment, the piezoelectric element 37 is used as a voltage generator; therefore, the mobile phone 10 can be configured to be lightweight and compact, and the voltage can be surely generated even with a low pressure of the fuel F which is the pressure when the fuel is supplied to the mobile phone 10.

Moreover, the valve control circuit 50A includes the latch circuit 53 to maintain the electrically connected state between the auxiliary power supply 41 and the first valve 36 even after the piezoelectric element 37 stops to generate voltage; therefore, even through the voltage generated by piezoelectric element 37 appears for a brief moment, the first valve 36 can continue to be electrically connected with the auxiliary power supply 41, whereby the first valve 36 can be maintained in the open state.

In addition, according to the mobile phone 10 of the embodiment, the voltage generated by the fuel cell 35 is first charged to the secondary cell 40, and then the charged power is supplied to various loads of the mobile phone 10; therefore, the mobile phone 10 can be driven with a stable power supply compared with the case where the power generated by the fuel cell 35 is directly supplied to the loads.

### Second Embodiment

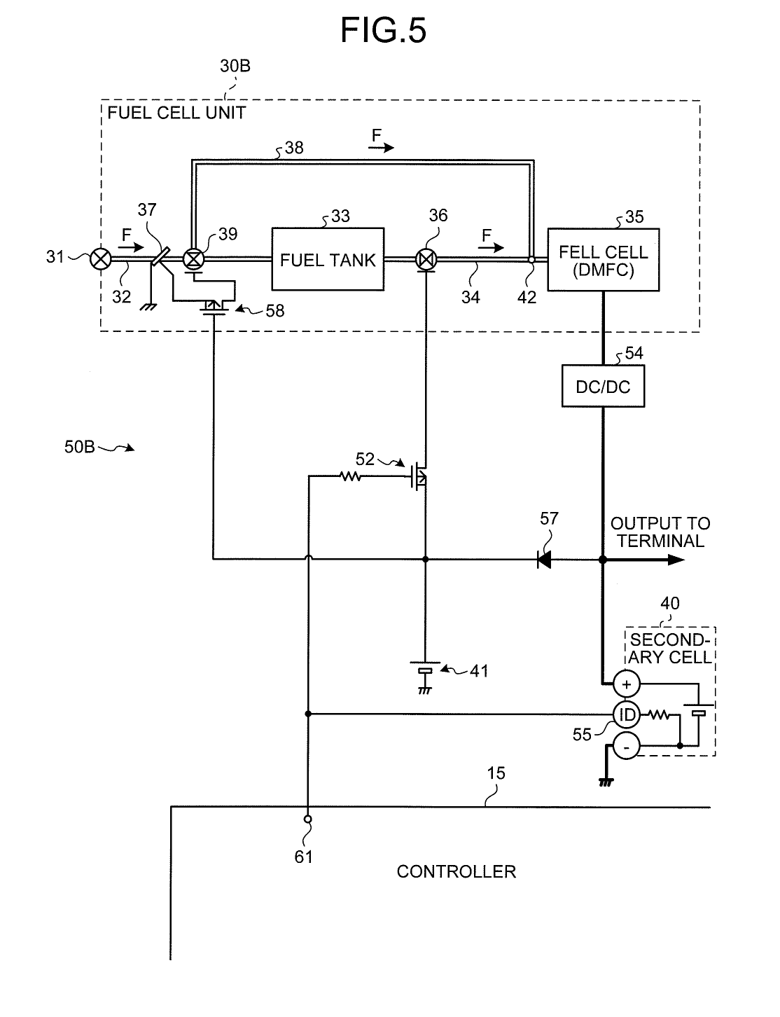

FIG. 5 is a block diagram of a fuel cell unit 30B and a valve control circuit 50B according to a second embodiment of the present invention. Hereafter, a description will be given with respect to a mobile phone according to the second embodiment. Since a basic structure of the mobile phone according to the second embodiment is the same as the mobile phone 10 illustrated in FIG. 1, the description will be given using FIGS. 1 and 2. Moreover, members that have the similar functions as those described in the above the first embodiment are denoted by the same reference letters, and the description thereof is not duplicated.

A fuel cell unit 30B is accommodated in the first housing 11 of the mobile phone 10 according to the second embodiment like the above-described first embodiment, and the fuel supply port 31 to take in fuel F, to be used in the fuel cell unit 30B, from the outside is provided in the end surface 16 of the hinge portion 13. Moreover, a valve control circuit 50B for controlling opening and closing of the first valve 36 of the fuel cell unit 30B, and the secondary cell 40 and the auxiliary power supply 41 to which electricity generated by the fuel cell 35 is charged are accommodated in the second housing 12 like the first embodiment.

The fuel cell unit 30B includes a bypass fluid channel 38 and a second valve 39 in addition to the fuel supply port 31, the first fluid channel 32, the fuel tank 33, the second fluid channel 34, the fuel cell 35, the first valve 36, and the piezoelectric element (voltage generator) 37 as illustrated in FIG. 5.

The bypass fluid channel 38 is piping that connects the first fluid channel 32 and the second fluid channel 34. The second valve 39 is installed in a connection between the first fluid channel 32 and the bypass fluid channel 39, and is configured as a directional control valve that selectively supplies fuel F which has been supplied from the fuel supply port 31 either to the first fluid channel 32 or the bypass fluid channel 38. A piezoelectric valve, an electromagnetic valve, or the like is used as the second valve 39. In the embodiment, the piezoelectric valve is used because it is lightweight and compact.

The piezoelectric element 37 is installed between the fuel supply port 31 and the second valve 39 in the first fluid channel 32 as illustrated in FIG. 5. Moreover, the first valve 36 is installed between a junction portion 42 of the bypass fluid channel 38 and the fuel tank 33 in the second fluid channel.

When the second valve 39 is switched to open the bypass fluid channel 38, an upstream side of the first fluid channel 32 comes to communicate with the bypass fluid channel 38, and the first fluid channel 32 that leads to fuel tank 33 is closed. Therefore, the fuel F supplied from the fuel supply port 31 is supplied to the bypass fluid channel 38, and hence supplied to the fuel cell 35 through the junction portion 42. On the other hand, when the second valve 39 is switched to open the first fluid channel, the upstream side of the first fluid channel 32 comes to communicate with a downstream side of the first fluid channel 32 that leads to the fuel tank 33, and the bypass fluid channel 38 is closed. Therefore, the fuel F that has been supplied from the fuel supply port 31 is supplied to the fuel tank 33, and hence is supplied to the fuel cell 35 through the first valve 36. The second valve 39 is in a state of being switched to open the first fluid channel under a normal condition, and as a result the fuel F that is supplied from the fuel supply port 31 is supplied to the fuel tank 33.

The first valve 36 is maintained in the closed state all the time except for a period during which charging is performed, and is switched from the closed state to the open state when the power is supplied from the secondary cell 40. Therefore, when the output voltage of the secondary cell 40 is insufficient and the fuel F is not stored in the fuel tank 33, the power cannot be supplied to the first valve 36 and a situation in which the first valve 36 that has been maintained in the closed state cannot be opened occurs. Regarding this situation, the embodiment is configured such that, when the fuel F is supplied from the fuel supply port 31 in such an emergency, a voltage is generated by the piezoelectric element 37 using the pressure of the fuel F, and this voltage is applied to the second valve 39. As a result, the second valve 39 is switched to the bypass fluid channel 38 side. Thus, as the fuel F is supplied to the fuel cell 35 through the bypass fluid channel 38 and the voltage generated by the fuel cell 35 is applied to the first valve 36, the first valve 36 is switched from the closed state to the open state.

The secondary cell 40 serves as a main power supply of the mobile phone 10 like the first embodiment, and supplies the power to various loads of the mobile phone 10. Moreover, the secondary cell 40 supplies the power to the first valve 36 in the fuel cell unit 30B so that the first valve 36 opens or closes.

The auxiliary power supply 41 is not configured to supply the power to various loads of the mobile phone 10 under a normal condition, but is used as an ancillary power supply under a condition in which the output power of the secondary cell 40 is insufficient, like the first embodiment.

The valve control circuit 50B includes a fourth field effect transistor 58 (hereinafter, referred to as “FET 58”) and the second field effect transistor 52 (FET 52). Moreover, the valve control circuit 50B includes the DC/DC convertor 54 (DC voltage converter) between the fuel cell 35 and the secondary cell 40, and is configured to boost the output voltage of the fuel cell 35 by using the DC/DC convertor 54 and to supply the resultant voltage to the secondary cell 40 and the auxiliary power supply 41.

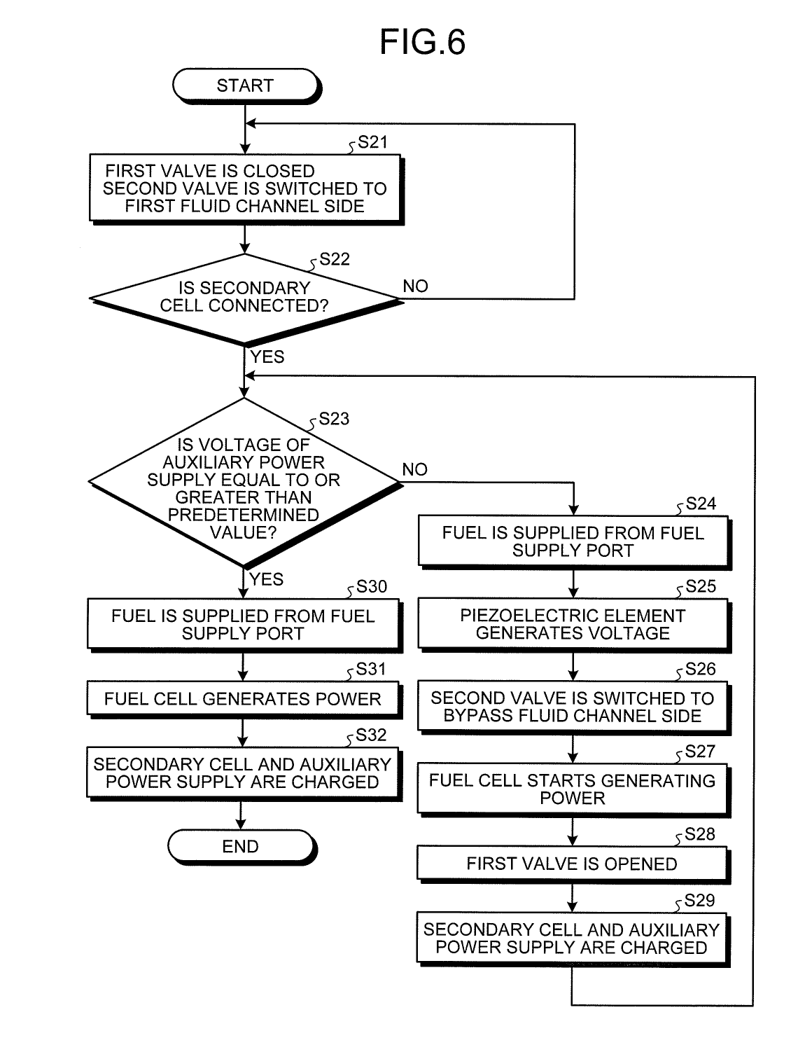

FIG. 6 is a flowchart illustrating the procedure to start the fuel cell 35 by using the valve control circuit 50B in the second embodiment. Hereafter, the above-mentioned procedure is described with reference to FIGS. 5 and 6.

Under a normal condition, the first valve 36 is maintained in the closed state, and the second valve 39 is switched to the first fluid channel side (Step S21). Under this condition, it is assumed that the output voltage of the secondary cell 40 drops to or below a predetermined value, and thus the first valve 36 cannot be opened. When a controller 15 determines that the secondary cell 40 is not in connection through a secondary cell detection terminal 61 (No in Step S22), the controller 15 performs control such that the first valve 36 is maintained in the closed state, the second valve 39 is switched to the first fluid channel side so as not to open the first valve. On the other hand, when it is determined that the secondary cell 40 is in connection (Yes in Step S22), the controller 15 determines whether the battery charge of the auxiliary power supply 41 remains. When the battery charge of the auxiliary power supply 41 drops below a predetermined threshold (No in Step S23), the control is performed such that the first valve 36 is opened by the valve control circuit 50B.

When a supply nozzle 21 of a fuel cartridge 20 is inserted into the fuel supply port 31 by the user under such a condition, and the fuel F is injected from the fuel supply port 31 at a certain pressure (Step S24), the piezoelectric element 37 installed in the first fluid channel 32 is deformed due to the pressure of the fuel F so that a voltage is generated (Step S25), and the voltage from the piezoelectric element 37 is applied to a source of the FET 58. In this case, the voltage of the auxiliary power supply 41 is equal to or below the predetermined value, and the gate of FET 58 is Low in level. Therefore, the voltage generated by the piezoelectric element 37 is applied from the source of the FET 58 to the second valve 39 through the gate of the FET 58. Thus, the second valve 39 is switched from the first fluid channel side to the bypass fluid channel side (Step S26). As a result, the fuel F is supplied to the bypass fluid channel 38, and to the fuel cell 35 through a junction portion 42, and power generation is started by the fuel cell 35 (Step S27). The voltage generated by the fuel cell 35 is boosted by the DC/DC convertor 54, and then the resultant voltage is applied to a source of the FET 52 through a diode 57. In this case, the gate of the FET 52 is Low in level. Therefore, the voltage of the fuel cell 35 is applied from the source of the FET 52 to the first valve 36 through the gate of the FET 52, and, as a result, the first valve 36 opens (Step S28).

Moreover, when the voltage of the fuel cell 35 is applied to the gate of the FET 58, the gate of the FET 58 becomes High in level and as a result the FET 58 is turned off (electrically disconnected state). Since the FET 58 is turned off, the second valve 39 is switched from the bypass fluid channel side to the first fluid channel side. As a result, the fuel F that has been supplied from the fuel supply port 31 is not supplied to the bypass fluid channel 38 but supplied to the first fluid channel 34 and to fuel tank 33. The fuel F passes through the first valve 36 being in the open state, and will be supplied to the fuel cell 35. The power generated by the fuel cell 35 is boosted up by the DC/DC convertor 54, and the resultant power is thereafter charged to the secondary cell 40 and the auxiliary power supply 41 (Step S29).

When the power generated by the fuel cell 35 is charged and the remaining battery charge of the auxiliary power supply 41 reaches a preset threshold (Yes in Step S23), the electronic device is switched to a normal charging mode. That is, when the fuel F is supplied from the fuel supply port 31 (Step S30), the fuel F is supplied to the fuel cell 35 through the fuel tank 33 and as a result power generation is performed (Step S31). The generated power is charged to the secondary cell 40 and the auxiliary power supply 41 (Step S32).

As described above, the mobile phone (electronic device) 10 of the second embodiment includes: the bypass fluid channel 38 that connects the first fluid channel 32 and the second fluid channel 34; the second valve which is installed in the connection between the first fluid channel 32 and the bypass fluid channel 38 and which selectively supplies the fuel F which is supplied from the fuel supply port 31 either to the first fluid channel 32 or to the bypass fluid channel 38; the piezoelectric element 37 provided in the first fluid channel, especially between the fuel supply port 31 and the second valve 39; and the valve control circuit 50B that switches the first valve 36 from the closed state to the open state based on the voltage generated by the piezoelectric element 37. Thereby, the valve control circuit 50B applies the voltage generated by the piezoelectric element 37 to the second valve 39 so that the second valve 39 will be switched to the bypass fluid channel side. Accordingly, the fuel F is supplied to the fuel cell 35 through the bypass fluid channel 38 so that the power generation will be performed by the fuel cell 35, and the voltage generated by this power generation is applied to the first valve 36 so that the first valve 36 will be switched from the closed state to the open state. According to the mobile phone 10 configured in the manner described above, even when both of the secondary cell 40 and the auxiliary power supply 41 are low in voltage and thus the voltage can be supplied to the first valve 36 neither from the secondary cell 40 nor from the auxiliary power supply 41, the first valve 36 can surely open and the fuel cell 35 can start.

Moreover, according to the mobile phone 10 of the second embodiment, the latch circuit used in the first embodiment is unnecessary, so that the valve control circuit can be implemented in a relatively simple structure. Moreover, the first valve 36 can be opened without using an additional power supply such as the auxiliary power supply 41.

Moreover, the mobile phone 10 of the second embodiment also uses the piezoelectric element 37 as the voltage generator; therefore, the mobile phone can be implemented in a lightweight and compact structure, and the voltage can be surely generated with a low pressure.

In addition, the mobile phone 10 of the second embodiment is also structured such that the voltage generated by the fuel cell 35 is first charged to the secondary cell 40, and then the charged power is supplied to various loads of the mobile phone 10; therefore, the mobile phone 10 can be driven with a stable power supply compared to the case in which the power generated by the fuel cell 35 is directly supplied to the loads.

The main idea of the valve control circuit used in the present disclosure is that the first valve 36 is switched from the closed state to the open state based on the voltage generated by the piezoelectric element 37. The configurations of the valve control circuit 50A in the first embodiment and the valve control circuit 50B in the second embodiment are provided as just examples, and the configuration of the valve control circuit is not limited thereto. That is, when the configuration of the valve control circuit and the arrangement of the first valve 36 and the second valve 39 are changed without departing from the main idea, the changed configurations and arrangements fall within the scope of one embodiment of the present invention.

### INDUSTRIAL APPLICABILITY

As mentioned above, an electronic device according to the present invention can be applied to mobile phones, PHSs, PDAs, portable navigation devices, notebook-sized personal computers, and the like in each of which a fuel cell is mounted.

1. An electronic device comprising:
a fuel supply port;
a fuel tank for storing a liquid fuel to be supplied from the first supply port through a first fluid channel;
a fuel cell for generating power by using the liquid fuel supplied from the fuel tank through a second fluid channel;
a first valve that is installed in the second fluid channel for controlling supply of the liquid fuel to the fuel cell;
a voltage generator that is installed in the first fluid channel for generating a voltage using a pressure of the liquid fuel that is supplied from the fuel supply port; and
a valve control unit for controlling an open/closed state of the first valve according to an application of the voltage.

2. The electronic device according to claim 1, wherein
the valve control unit switches the first valve to the open state based on the voltage generated by the voltage generator.

3. The electronic device according to claim 2, further comprising
an auxiliary power supply that is switched to an electrically connected state or an electrically disconnected state with respect to the first valve by the valve control unit, wherein
the valve control unit switches the auxiliary power supply and the first valve from the electrically disconnected state to the electrically connected state to apply a voltage of the auxiliary power supply to the first valve so that the first valve is switched from the closed state to the open state.

4. The electronic device according to claim 3, wherein
the valve control unit includes a latch circuit for maintaining the electrically connected state between the auxiliary power supply and the first valve.

5. The electronic device according to claim 1, further comprising:
a bypass fluid channel that connects the first fluid channel and the second fluid channel; and
a second valve that is installed in a connection between the first fluid channel and the bypass fluid channel for selectively supplying the liquid fluid supplied from the fluid supply port either to the first fluid channel or to the bypass fluid channel, wherein
the voltage generator is installed in the first fluid channel and between the fuel supply port and the second valve, and
the valve control unit applies the voltage generated by the voltage generator to the second valve so that the second valve is switched to a state in which the bypass fluid channel and the first fluid channel communicate with each other, supplies the liquid fluid to the fluid cell through the bypass fluid channel so that power is generated by the fuel cell, and applies the voltage generated by the power generation to the first valve so that the first valve is switched from the closed state to the open state.

6. The electronic device according to claim 1, wherein
the voltage generator is a piezoelectric element.

7. The electronic device according to claim 1, further comprising
a secondary cell configured to be charged with a voltage generated by the fuel cell.
